(19) United States
(12) Patent Application Publication
(10) Pub. No.: US 2003/0145875 A1
(43) Pub. Date: Aug. 7, 2003

(54) Apparatus and methods for cleaning semiconductor wafers using vaporized chemicals

(75) Inventors: Dong-Gyun Han, Seoul (KR); Kun-Tack Lee, Suwon-City (KR); Yong-Pil Han, Kwanak-gu (KR); Hyung-Ho Ko, Seoul (KR)

Correspondence Address: F. Chau & Associates, LLP, Suite 501, 1900 Hempstead Turnpike, East Meadow, NY, 11554, US

(73) Assignee: Samsung Electronics Co., Ltd.

(21) Appl. No.: 10/357,098

(22) Filed: Feb. 3, 2003

(30) Foreign Application Priority Data
Feb. 2, 2002 (KR) 02-6045

(51) Int. Cl. B08B 7/00

(52) U.S. Cl. 134/9

(57) ABSTRACT

An apparatus for cleaning a semiconductor wafer includes a cleaning reaction chamber wherein the cleaning process is performed in a closed state, a wafer conveyor having wafer supporters for loading semiconductor onto a loading unit within the reaction chamber, at least one cleaning gas supply unit for supplying at least one cleaning solution in a vapor state into the reaction chamber, a water vaporizing unit for supplying vapor onto the semiconductor wafers, an ozone supply unit for supplying ozone gas into the reaction chamber, and a reaction gas exhaustion unit connected to the reaction chamber in order to exhaust the cleaning gas from the reaction chamber. The cleaning of the semiconductor wafers by adding cleaning gas and ozone gas into a reaction chamber easily removes any remaining photoresist that formed on the semiconductor wafers and any other contaminates from pre-processes.

### CROSS-REFERENCE TO RELATED APPLICATION

This application claims priority to Korean Patent Application No. 2002-6045, filed Feb. 2, 2002, which is incorporated herein by reference.

### BACKGROUND OF THE INVENTION

1. Field of the Invention

The present invention, generally, relates to an apparatus and a method for cleaning a semiconductor wafer. More particularly, the present invention relates to an apparatus and methods for cleaning a semiconductor wafer using vaporized chemicals.

2. Description of the Related Art

As semiconductor devices become more highly integrated, it is important that the semiconductor devices are properly cleaned. Generally, there is a cleaning process for each major fabrication style, which includes a pre-cleaning process that cleans a semiconductor wafer before fabricating processes, a photoresist cleaning process that removes a photoresist after photolithography and etch processes performed as patterning processes, and a wet etch process that wet etches a semiconductor insulating layer with etchant solution. The photoresist cleaning process needs to be performed before proceeding to subsequent processes, since a photoresist is formed of polymers which includes a large amount of heavy metal and carbon that may contaminate a semiconductor wafer.

Typically, the semiconductor device is cleaned using a sulfuric acid solution at a high temperature to remove the excess photoresist in a photoresist cleaning process. A semiconductor wafer is immersed in a sulfuric acid solution, and the solution is bubbled to remove the photoresist by physical and chemical methods.

Since a dry etching process or an ion implanting process is generally performed on a patterned photoresist, the photoresist as a mask is exposed to plasma or ions of high energy level so that the surface of the photoresist may be hardened. Accordingly, an unevenly hardened layer, which is not easily cleaned by a cleaning solution, is formed on the surface of the photoresist. The hardened photoresist cannot be completely removed from the surface of the semiconductor wafer by a conventional photoresist cleaning process, e.g. the method using sulfuric acid described above. As a result, the photoresist contaminates cause frequent failure of the apparatus used in fabricating a semiconductor device and the semiconductor wafers in a subsequent deposition process and a thermal process, and thereby wasting semiconductor wafers. In addition, cleaning the contaminated apparatus is time-consuming and highly expensive. Therefore, a need exists for a method for cleaning a semiconuctor wafer to easily remove a photoresist even if the photoresist has been hardened by plasma or ions of high energy level in a photolithography process.

### SUMMARY OF THE INVENTION

According to an embodiment of the present invention, an apparatus is provided for cleaning a semiconductor wafer includes a reaction chamber for performing a cleaning process, at least one cleaning gas supply unit for supplying at least one cleaning solution in a gaseous state into the reaction chamber, an ozone supply unit for supplying ozone gas into the reaction chamber, a water vaporizing unit for supplying water vapor onto the semiconductor wafers in the reaction chamber, and a reaction gas exhaustion unit connected to the reaction chamber, for exhausting the cleaning gas from the reaction chamber. Further, the reaction chamber may be sealed from the surrounding atmosphere to prevent the contamination of the wafers during the cleaning process, according to another embodiment of the present invention.

The reaction chamber further includes a wafer loading unit for loading at least one semiconductor wafer into the reaction chamber, and a wafer conveyor for transferring the semiconductor wafers to the wafer loading unit. Accordingly, the wafer loading unit can load one cassette, e.g., 25 semiconductor wafers, to improve throughput of the apparatus according to the present invention. The reaction chamber further includes a reaction chamber heating unit that substantially surrounds the outer sides of the reaction chamber to furnish heat to the inside of the reaction chamber so that the temperature in the reaction chamber is uniformly maintained in order to conveniently perform a cleaning process in the reaction chamber. Accordingly, it is preferable that the reaction chamber is heated to a predetermined temperature, e.g., 80 to 150° C.

The cleaning gas supply unit includes a cleaning solution supply unit for storing the cleaning solution, and a solution vaporization unit connected to the cleaning solution supply unit, for vaporizing the cleaning solution, so that the vaporized cleaning solution is supplied into the reaction chamber. Here, in order to improve a cleaning efficiency of the semiconductor wafers, the cleaning solution is one of hydrofluoric acid (HF), ammonium hydroxide (NH₄OH), and hydrogen peroxide (H₂O₂). The cleaning solution supply unit further includes a bubbling pipe for supplying bubbling gas into the cleaning solution supply unit and bubbling the gas through the cleaning solution. The bubbling gas is one of helium, argon, and nitrogen gas. The bubbling gas is supplied to the cleaning solution supply unit and is bubbled through the cleaning solution thereby forming a vaporized cleaning gas. Accordingly, the cleaning solution is converted from a liquid state to a vapor state. The vaporized cleaning solution is then supplied into the reaction chamber.

The cleaning solution may also be converted to a gas by a vaporization unit. The vaporization unit is a spray device applied according to Bernoulli's law to conveniently vaporize the cleaning solution at a room temperature.

The ozone supply unit includes an ozone generator, which generates ozone gas by disassociating and recombining source gas including oxygen atoms, so that the ozone gas can be uniformly supplied without requiring a separate ozone tank.

A water vaporizing unit heats distilled water used for cleaning a semiconductor wafer at a predetermined temperature to generate vapor and supplies the water vapor into the reaction chamber heated at a predetermined temperature. Accordingly, the vaporized cleaning solution is mixed with the distilled water vapor and adsorbed on the semiconductor wafers to react on the surfaces of the semiconductor wafers and perform a cleaning process.

Due to gravity, the reaction gases that have been used during the cleaning process tend to build up in a lower portion of the reaction chamber. Therefore, the cleaning gas exhaustion unit is disposed at a lower portion of the reaction chamber to easily exhaust the reaction gases that have been used in the cleaning process. In addition, this prevents the reaction gases from flowing backward and contaminating the semiconductor wafers. The cleaning gas exhaustion unit further includes a gas scrubber installed at the outside of the reaction chamber to remove any contaminants in the reaction gases, thereby preventing environmental contamination.

In performing the cleaning process, the reaction chamber maintains a process pressure over one atmosphere. Here, the process pressure is controlled by controlling the amount of reaction gases supplied into the reaction chamber and the amount of the exhaustion gas exhausted from the reaction chamber. It is preferable that the process pressure is about 1.5 to about 3 atmospheres.

A method for cleaning a semiconductor wafer using the above-described apparatus loads a plurality of semiconductor wafers into a reaction chamber. Then, the cleaning solution and distilled water are vaporized. Next, the vaporized cleaning solution (or cleaning gas), vaporized distilled water, and ozone gas are prepared to be input into the reaction chamber. Predetermined amounts of the prepared cleaning gas, vaporized distilled water, ozone gas are supplied into the reaction chamber. The cleaning gas, the ozone gas, and the vaporized distilled water contact the semiconductor wafers to clean the semiconductor wafers while exhausting predetermined amounts of cleaning gas and ozone gas out of the reaction chamber to maintain desired process pressure.

Here, a method for vaporizing the cleaning solution includes either a method of heating the cleaning solution to a predetermined temperature and bubbling an inactive gas through the cleaning solution to generate a cleaning gas, or by a method of spraying the cleaning solution using a spray method, e.g., Bernoulli's law, using a pressure difference. Here, it is advantageous to use different solutions to remove different contaminants. For example, the advantage of using HF solution as a cleaning solution is that the HF solution easily removes polymer particles on the semiconductor wafers. In addition, the HF may be directly supplied into the reaction chamber in a gaseous state. The advantage in using NH₄OH solution as a cleaning solution is that the NH₄OH solution removes fine particles. In addition, when the cleaning solution includes H₂O₂, the reaction on the surfaces of the semiconductor wafers improves the ability of the cleaning solution to remove transformed particles. Further, the reaction chamber may be heated to a predetermined temperature.

In the method of supplying the ozone gas, an ozone generator generates the ozone gas and supplies the ozone gas into the reaction chamber. Here, the cleaning gas and the ozone gas are supplied into the reaction chamber through different supply lines and mixed in the reaction chamber. Accordingly, the cleaning gas and the ozone gas are prevented from contacting before reaching the semiconductor wafers and generating a pre-reaction. In addition, the cleaning gas and the ozone gas are supplied from an upper portion of the reaction chamber to flow in a downward direction and pass between the semiconductor wafers so that the cleaning gas and the ozone gas are prevented from flowing backward. Alternatively, the cleaning gas, the vaporized distilled water, and the ozone gas may be sprayed from different directions onto the semiconductor wafers. Further, the cleaning gas, the vaporized distilled water, and the ozone gas may be mixed and supplied into the reaction chamber.

On the other hand, it is preferable that the supplied amounts of the cleaning gas and the ozone gas are larger than the exhausted amount the gases so that the reaction chamber maintains a process pressure of greater than one atmosphere. Accordingly, the densities of the cleaning gas and the ozone gas contacting the semiconductor wafers increase and improve cleaning efficiency. Here, it is preferable that the process pressure is about 1.5 to about 3 atmospheres.

The semiconductor wafers are placed parallel to the flow of the cleaning gas and the ozone gas being supplied into the reaction so that the semiconductor wafers smoothly receive the gases and the gases smoothly flow on the surfaces of the semiconductor wafers. Therefore, the cleaning process can be uniformly performed.

The apparatus for cleaning a semiconductor wafer according to the present invention supplies a vaporized cleaning solution onto semiconductor wafers along with ozone gas to conveniently remove photoresist or particles from the semiconductor wafers. In addition, even in the case of a hardened by-product, which is formed by implanting plasma or ion energy of a high level into a photoresist in a dry etching process or an ion implanting process, on the semiconductor wafer, the hardened by-product can be easily removed by adding cleaning gases.

### BRIEF DESCRIPTION OF THE DRAWINGS

The above objective and advantages of the present invention will become more apparent by describing in detail preferred embodiments thereof with reference to the attached drawings in which:

FIG. 1 is a schematic view illustrating an apparatus for cleaning a plurality of semiconductor wafers, according to an embodiment of the present invention;

FIG. 2 is a schematic view illustrating a loading unit shown within the reaction chamber of an apparatus for cleaning semiconductor wafers, according to an embodiment of the present invention;

FIG. 3A is a side view illustrating a wafer transfer unit and a wafer loading unit for transporting semiconductor wafers into and out of a reaction chamber, according to an embodiment of the present invention;

FIG. 3B is a perspective view of a wafer loading unit and a wafer conveyor according to an embodiment of the present invention;

FIG. 3C is a bottom view illustrating the wafer conveyor of FIG. 3B;

FIGS. 4A and 4B are sectional views illustrating a cleaning solution supply unit, according to an embodiment of the present invention;

FIG. 5 is a flowchart of a method for cleaning a plurality of semiconductor wafers according to the present invention; and

FIG. 6 is a schematic view illustrating an apparatus for cleaning a plurality of semiconductor wafers, according to another embodiment of the present invention.

### DETAILED DESCRIPTION OF THE INVENTION

The present invention will now be described more fully with reference to the accompanying drawings, in which preferred embodiments of the invention are shown. This invention may, however, be embodied in many different forms and should not be construed as being limited to the embodiments set forth herein. Rather, these embodiments are provided so that this disclosure will be thorough and complete, and will fully convey the concept of the invention to those skilled in the art.

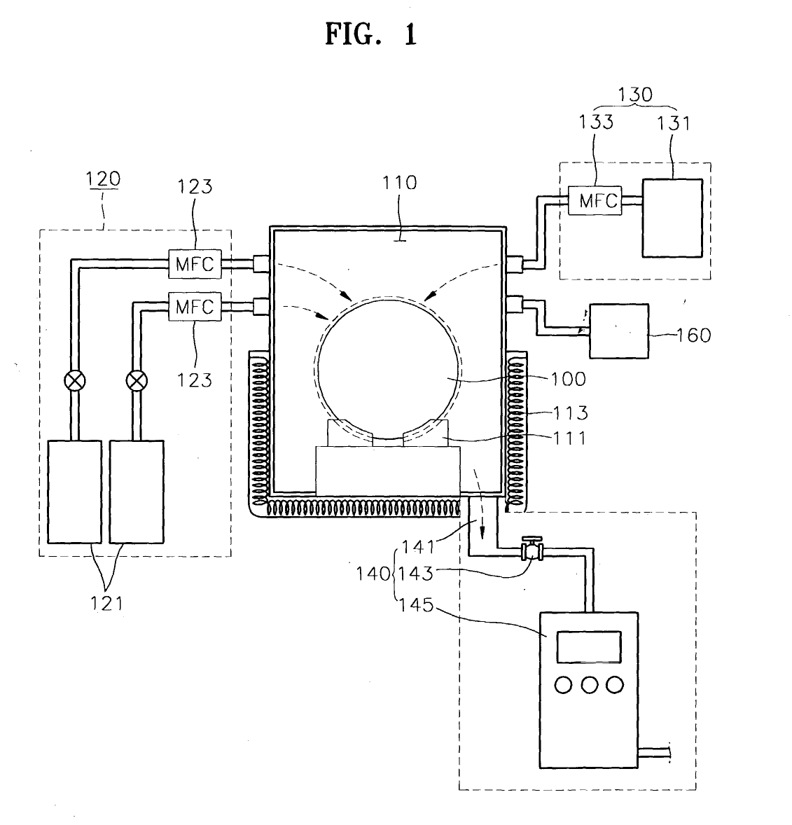

FIG. 1 is a schematic view illustrating an apparatus for cleaning a plurality of semiconductor wafers, according to an embodiment of the present invention.

Referring to FIG. 1, the apparatus for a cleaning process of a semiconductor wafer includes a reaction chamber 110 having a loading unit 111 on which at least one semiconductor wafer 100 can be loaded, a cleaning gas supply unit 120 connected to the reaction chamber 110 to supply cleaning gas, an ozone gas supply unit 130 for supplying ozone gas to the reaction chamber 110, a water vaporizing unit 160 for supplying vaporized distilled water into the reaction chamber 110, and a gas exhaustion unit 140, connected to an exhaustion hole 141 disposed at a lower portion of the reaction chamber 110, to exhaust the gases in the reaction chamber to the outside.

An ozone gas supply unit 130 is arranged above the level of the plurality of semiconductor wafers 100 in the reaction chamber 110 while having a different supply route from that of a cleaning gas supply unit 120. Here, the ozone gas supply unit 130 includes an ozone generator 131 for generating ozone gas by activating oxygen, and the ozone gas is injected into the reaction chamber 110 through a predetermined injection unit (not shown). Here, the injection unit includes a mass flow control, MFC 133, for controlling the flow rate of the ozone gas.

A gas exhaustion unit 140, installed under the reaction chamber 110, includes an exhaustion hole 141 located at the bottom of the reaction chamber 110 to exhaust the cleaning gas and ozone gas that have undergone a cleaning reaction by passing between semiconductor wafers 100, and a gas scrubber 143 connected to the exhaustion hole 141 to purify the reaction gas. Here, the gas exhaustion unit 140 further includes an exhaustion gas controller 145 for controlling the exhausting rate of the exhausted reaction gas. The exhaustion gas controller 145 may be of a butterfly type or a needle valve type.

Since the flows of the cleaning gas and the ozone gas supplied into the reaction chamber 110 are controlled and the exhausting rate of the exhaustion gas is controlled, the pressure in the reaction chamber 110 can be maintained at a high level. In other words, when the flow rate of the reaction gases are controlled to be larger than the exhausting rate of the exhaustion gas, the pressure of the reaction chamber 110 becomes higher than one atmosphere. It is preferable that the pressure of the reaction chamber is about 1.5 to 3 atmospheres.

In addition, the reaction chamber 110 further includes a heating unit 113 for uniformly heating the reaction chamber 110 to a predetermined temperature, e.g. 80° C. to 150° C. Preferably, the reaction chamber heating unit 113 surrounds the outer walls of the reaction chamber 110 to uniformly heat the reaction chamber 110 and process gases. In addition, the heating unit 113 may be arranged along the inner walls of the reaction chamber 110 to heat the gases in the reaction chamber 110. The heating unit 113 may also be of a heater jacket type or a predetermined coil resistant heater in the reaction chamber 110. The reaction chamber heating unit 113 may also be of a radiation type heating unit having a lamp to heat only the semiconductor wafers 100 by radiating the inside of the reaction chamber 110.

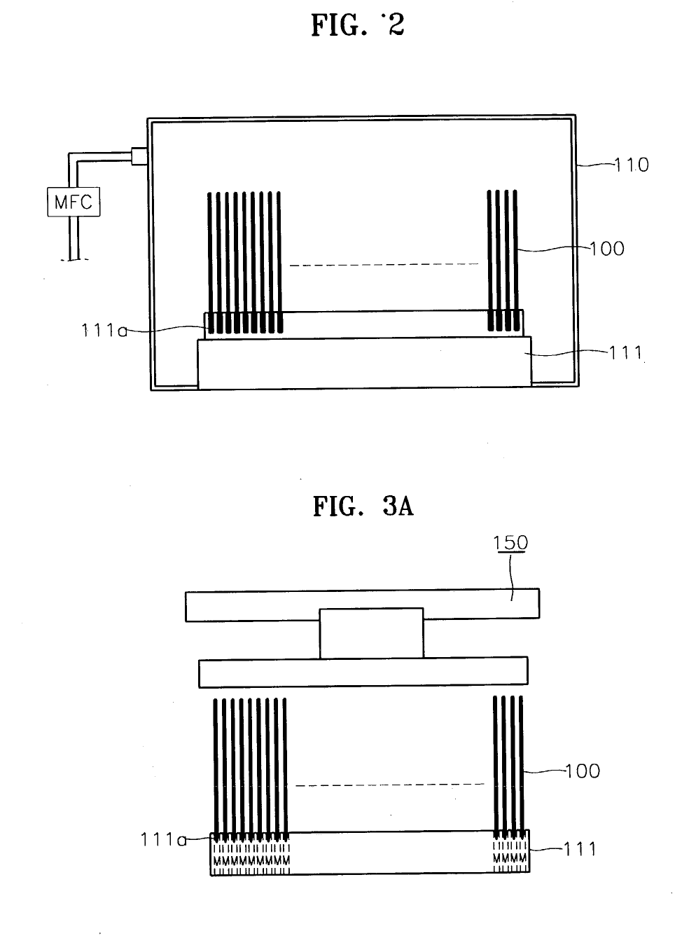

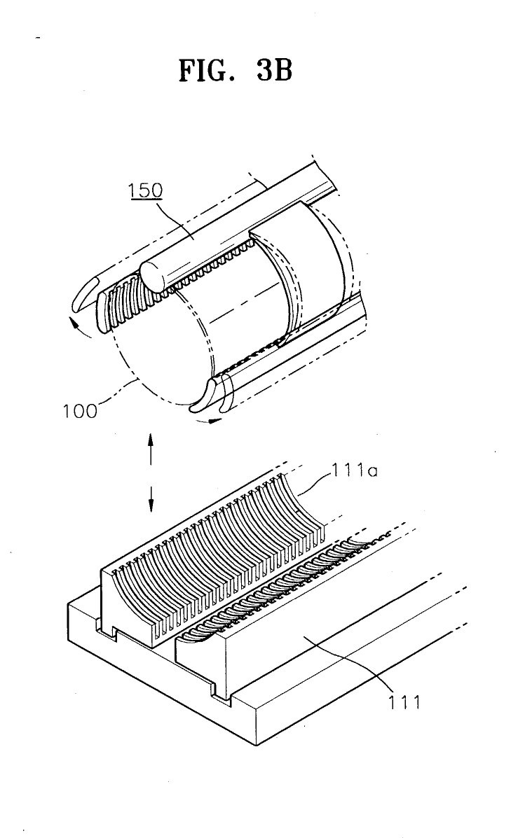

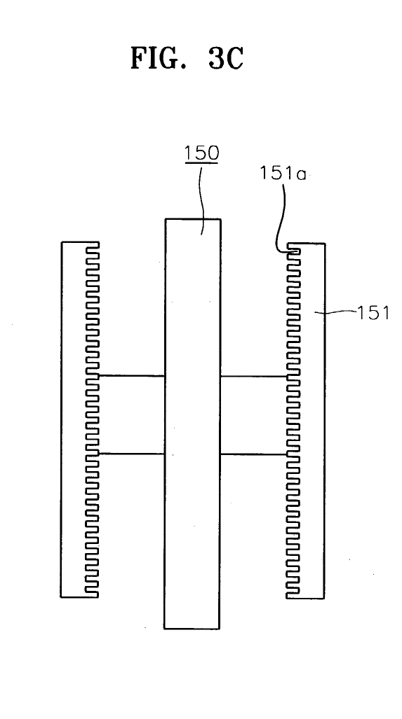

FIGS. 2 and 3A through 3C are views illustrating a conveying unit and a loading unit for loading and unloading semiconductor wafers into and out of the reaction chamber according to the present invention.

Referring to FIGS. 2 and 3A through 3C, illustrates a reaction chamber 110 further including a wafer transfer unit 150 and a loading unit 111. Preferably, the wafer transfer unit 150 is located adjacent to the outer side of the reaction chamber 110. The wafer transfer unit 150 loads semiconductor wafers 100 onto a loading unit 111 that has a plurality of slots 111a on which a plurality of semiconductor wafers 100 can be loaded. Accordingly, the throughput of the apparatus for cleaning a plurality of semiconductors wafer can be improved.

FIG. 2 is a schematic view illustrating a reaction chamber 110 with a loading unit 111 as part of the apparatus for cleaning semiconductor wafers 100, according to an embodiment of the present invention. More specifically, FIG. 2 illustrates a loading unit 111 holding a plurality of semiconductor wafers 100 inside a reaction chamber 110.

FIG. 3A is a side view illustrating a wafer transfer unit 150 and a wafer loading unit 111 for transporting semiconductor wafers into and out of the reaction chamber according to the present invention. More specifically, FIG. 3A illustrates a wafer transfer unit 150 positioned over a wafer loading unit 111, which is loaded with a plurality of semiconductor wafers 100 within the slots 111a formed in the loading unit 111.

FIG. 3B is a perspective view illustrating a wafer loading unit and a wafer conveyor according to the present invention. FIG. 3C is a bottom view illustrating the wafer conveyor. Referring to FIGS. 3B and 3C, a wafer conveyor 150 has two wafer transfer supporters 151 having a plurality of slots 151a to transfer a plurality of semiconductor wafers 100, a wafer center support 152, two arms 153 each pivotally connected to the wafer center support 152, and two wafer transfer supporters 151 each pivotally connected to one of the two arms 153. The wafer transfer supporters 151 fasten and unfasten in lateral directions to hold and release the semiconductor wafers 100 in order to load and unload semiconductor wafers 100 onto and off the loading unit 111. In addition, the slots 151a formed in the wafer transfer supporters 151 correspond to the slots 111a formed in the wafer loading unit 111.

Accordingly, a wafer conveyor loads the semiconductor wafers 100 onto the loading unit 111 in the reaction chamber 110, the semiconductor wafers 100 are loaded into the slots 151a on the wafer transfer supporters 151 of the wafer conveyor 150 and the wafer conveyor 150 moves into the reaction chamber 110 with a load of semiconductor wafers 100. Thereafter, the slots 111a in the loading unit 111 and the slots 151a of the wafer transfer supporters 151 are aligned, and the wafer conveyor 150 is lowered to spread out the wafer transfer supporters 151 so that the semiconductor wafers 100 are transferred to the loading unit 111 thereby completing the loading of the semiconductor wafers 100. When the cleaning process is finished, the semiconductor wafers 100 are unloaded by performing the unloading process of the semiconductor wafers 100 in reverse order of the loading process.

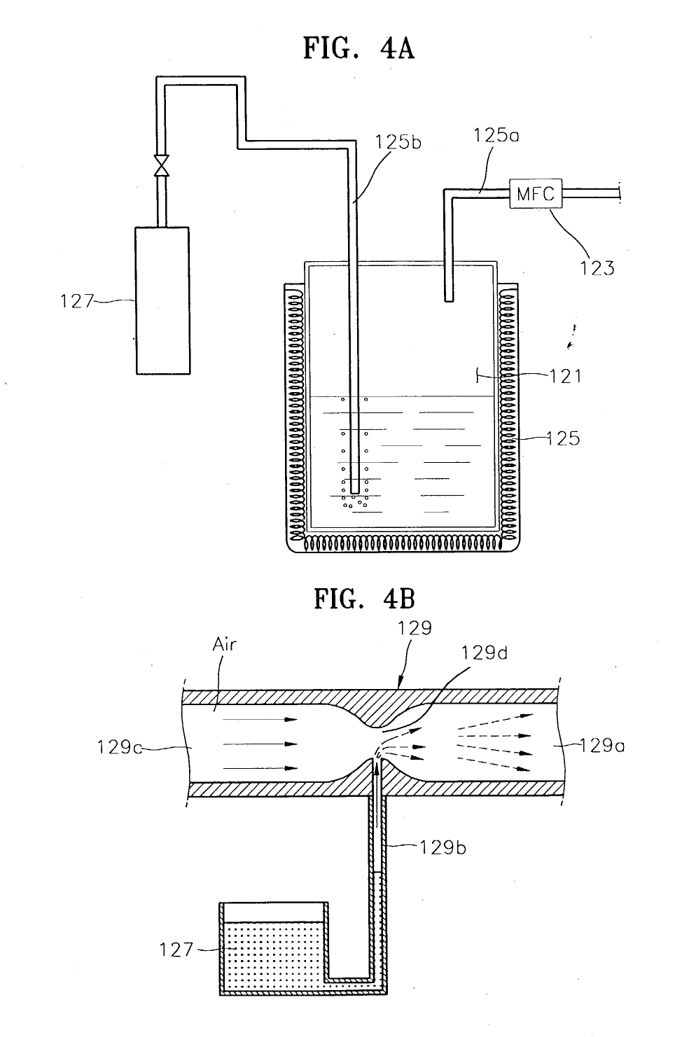

FIG. 4A is a schematic view of a cleaning gas supply unit 120 according to an embodiment of the present invention. Referring to FIG. 4A, a cleaning gas supply unit 120 includes a cleaning solution unit 121 for storing a cleaning solution in a liquid state, a heating unit 125 substantially surrounding the cleaning solution unit 121 to furnish heat to a cleaning solution and to raise the temperature of a cleaning solution to a predetermined temperature, an inactive gas supply unit 127 for supplying inactive gas into the cleaning solution through an inactive gas supply pipe 125b connected to and extending down to a lower portion of the cleaning solution unit 121, and a cleaning gas supply pipe 125a for supplying a vaporized cleaning solution into a reaction chamber 110. Here, a gas flow controller 123, such as a mass flow controller (MFC), can be further included in the cleaning gas supply pipe 125a to control the flow rate of the cleaning gas.

The cleaning solution used for cleaning a semiconductor wafer (100) may be an ammonium hydroxide (NH₄OH) solution for removing particles, a hydrofluoric acid (HF) solution, or a hydrogen peroxide (H₂O₂) solution for removing polymers. The cleaning solution is supplied to the reaction chamber 110 via the cleaning gas supply pipe 125a onto the semiconductor wafers 100 with distilled water. Since vaporized cleaning gas cannot react with the particles on the surfaces of the semiconductor wafers 100, the distilled water is supplied to adsorb the cleaning gas and adhere the cleaning gas onto the surfaces of the semiconductor wafers 100.

FIG. 4B is a schematic view illustrating a vaporizer, according to another embodiment of the present invention. Generally, the vaporizer 129 is installed between a cleaning solution tank 127 for storing a cleaning solution and a reaction chamber 110. Now referring to FIG. 4B, a vaporizer 129 includes a spray gas supply hole 129c for supplying inactive gas to a spray unit 129d, a spray unit 129d for receiving a cleaning solution in a liquid state from a cleaning solution tank 127 via a cleaning solution pipe 129b and the inactive gas from the spray gas supply hole 129c in order to vaporize the cleaning solution and forming a cleaning gas, and a cleaning gas supply pipe 129a connected to the spray unit 129d for inducing the cleaning gas sprayed from the spray unit 129d into the reaction chamber 110. More specifically, the spray unit 129d having a smaller diameter than the spray gas supply hole 129c and the cleaning gas supply pipe 129a is positioned perpendicular to the flow of the cleaning solution being supplied through the cleaning solution pipe 129b. The vaporizer 129 uses a vaporization principle under Bernoulli's law so that a cleaning solution in a liquid state can be easily converted into cleaning gas at room temperature without heating. A cleaning gas flow controller 123, such as MFC as shown in FIG. 4A, may be arranged between the cleaning gas supply pipe 129a of the vaporizer 129 and the reaction chamber 110 in order to control the flow rate of the cleaning gas.

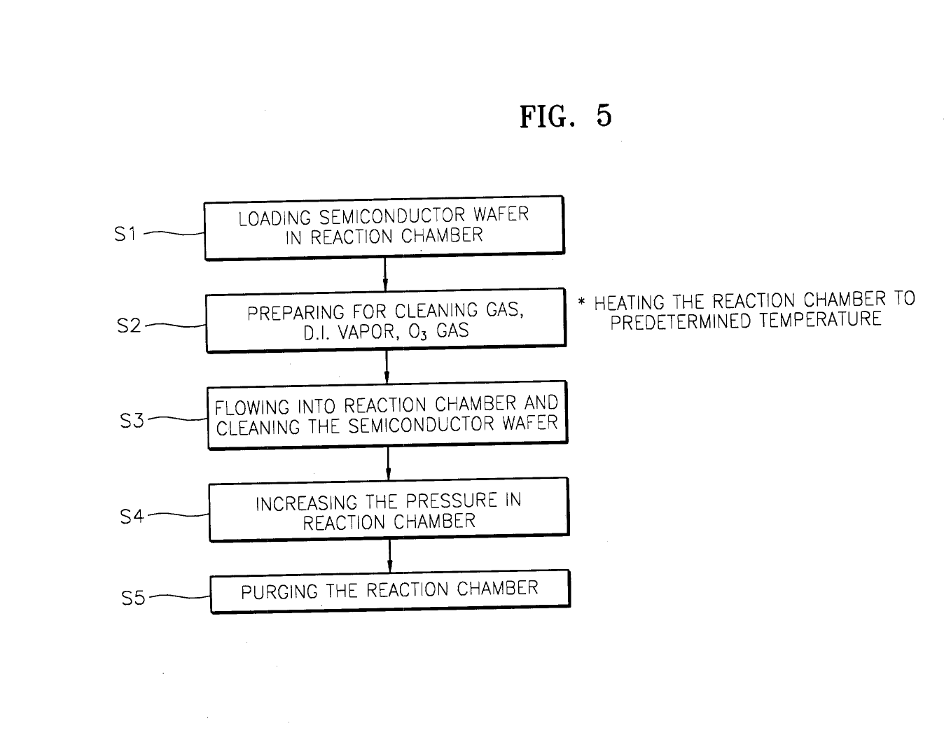

FIG. 5 is a flowchart of a method for cleaning a plurality of semiconductor wafers, according to an embodiment of the present invention.

Referring to FIG. 5, initially, a plurality of semiconductor wafers are transferred to a loading unit located inside a reaction chamber by using a wafer conveyor (step s1).

Then, the reaction chamber is sealed, and the cleaning gas, vaporized distilled water, and ozone gas are prepared before being supplied into the reaction chamber (step s2).

In preparing the cleaning gas, the heating unit of the cleaning gas supply unit is turned on thereby heating the cleaning solution. And, an inactive gas, such as argon (Ar), helium (He), or nitrogen (N₂), is supplied into the cleaning solution unit 121 and passes through the cleaning solution so that the cleaning solution is vaporized. It should be note that the cleaning solution may also be vaporized by the embodiment disclosed in reference to FIG. 4B above. The vaporized distilled water is generated by either heating distilled water at a temperature over a vaporization point or by a spray method at a room temperature. Operating an ozone generator of an ozone gas supply unit generates the ozone gas. In addition, a reaction chamber heating unit is turned on to heat the inside of the reaction chamber to a predetermined temperature, e.g. about 80 to 150° C. The temperature in the reaction chamber is slightly lower than the temperature of the cleaning gas being supplied into the reaction chamber. This causes the cleaning gas being supplied into the reaction chamber to be transformed from a vapor state into a liquid state thereby enhancing the cleaning reaction in the reaction chamber 110.

The cleaning gas, ozone gas, and vaporized distilled water are supplied into the reaction chamber to perform a cleaning process (step s3). Here, the cleaning gas is supplied into the reaction chamber through a cleaning gas supply pipe that has a mass flow control (MFC) controlling the flow rate of the cleaning gas. The ozone gas generated in an ozone generator is supplied into the reaction chamber while the flow rate of the ozone gas is controlled by an MFC. The cleaning gas and the ozone gas are simultaneously supplied into the reaction chamber. The cleaning gas, ozone gas, and vaporized distilled water flow from an upper portion of the reaction chamber in a downward direction to pass between the plurality of semiconductor wafers 100, which are parallel to the flowing direction of the gases, and in contact with the plurality of semiconductor wafers. Accordingly, the mixture of the cleaning gas and the ozone gas contact and chemically react with the contaminants on the surface of the semiconductor wafers to clean the surfaces of the plurality of semiconductor wafers.

At the same time, the exhausting rate of the exhaustion gas is controlled by the gas exhaustion unit to maintain the pressure of the reaction chamber over one atmosphere (step s4). The pressured state in the reaction chamber is maintained by removing a smaller quantity of exhaust gas than the combine quantity of the cleaning gas, the ozone gas, and the vaporized distilled water being supplied to the reaction chamber. It is preferable that the pressure of the reaction chamber is about 1.5 to about 3 atmospheres. In particular, in the pressurized state, the densities of the cleaning gas and the ozone gas contacting the surfaces of the semiconductor wafers increases thereby improving the cleaning reaction and the cleaning efficiency of the semiconductor wafer.

When the cleaning process is completed, the reaction chamber is purged by using inactive gas to remove the cleaning gas and the ozone gas (step s5). Here, argon or N₂ gas is used as purge gas. After purging the reaction chamber, the reaction chamber is opened and the semiconductor wafers are removed from the reaction chamber using the wafer conveyor.

An apparatus for cleaning a semiconductor wafer according to the present invention supplies a cleaning solution, in a vaporized state, and ozone gas onto the surfaces of a plurality of semiconductor wafers. Therefore, particles or a photoresist formed on the surfaces of the plurality of semiconductor wafers actively reacts with the cleaning solution, thereby easily performing the cleaning process. In addition, a cleaning solution as a catalyst for a specific layer is added to the cleaning gas. Thus, the photoresist, which is hardened by dry etching or ion implanting process and not likely to be removed by a conventional sulfuric acid strip method, can be completely removed due to the complex operation of the cleaning gas and the ozone gas.

On the other hand, the apparatus for cleaning a plurality of semiconductor wafers substantially surrounds a heating unit around a cleaning solution unit, which stores a cleaning solution, to vaporize the cleaning solution, or a vaporizer using a spray principle is installed between a cleaning solution storage tank and a reaction chamber, so that the apparatus can effectively vaporize the cleaning solution.

In addition, when a gas exhaustion unit includes an exhaustion gas conditioner along with the gas scrubber, the gas exhaustion unit withdraws the gas from the reaction chamber at a predetermined pressure, e.g. about 1.5 to 3 atmospheres. Accordingly, the cleaning gas and the ozone gas that have undergone a cleaning process do not remain in the reaction chamber but are exhausted out of the reaction chamber so that the plurality of semiconductor wafers are prevented from being contaminated by the gases that have undergone the cleaning process.

A separate supply pipe and a gas supply unit may be added to the apparatus for a cleaning process of a semiconductor wafer to supply HF in a vaporized state into the reaction chamber. Accordingly, a negative reaction by adding the HF into the cleaning solution in a liquid state can be prevented to improve a cleaning efficiency.

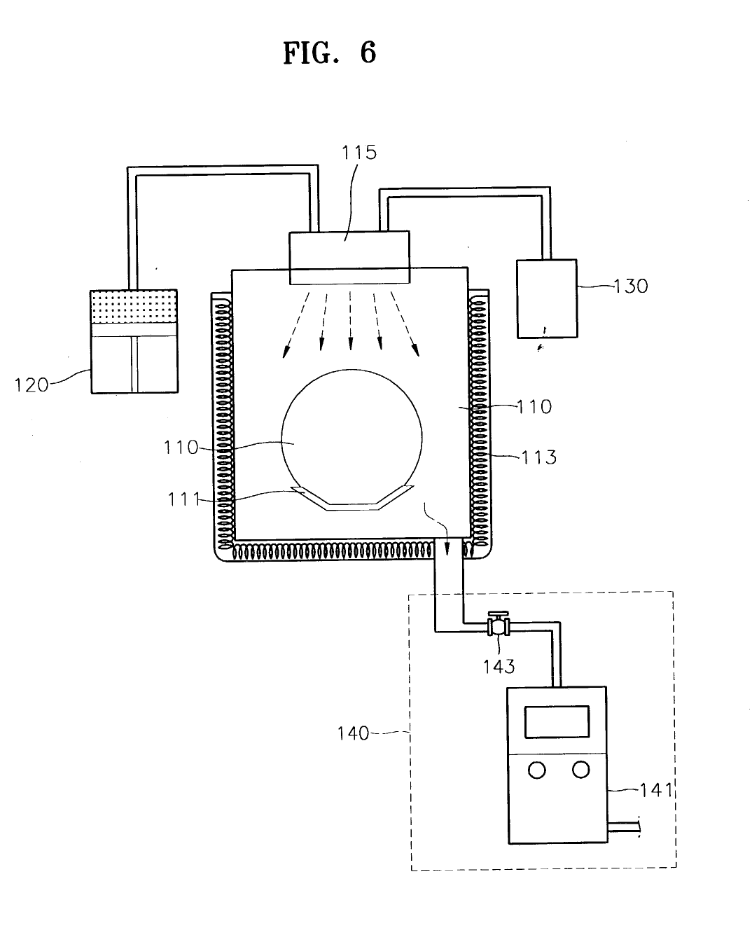

FIG. 6 is a schematic view illustrating an apparatus for a cleaning process of a semiconductor wafer according to another embodiment of the present invention. Descriptions of the same elements as the elements of the first embodiment of the present invention will be omitted. The apparatus according to this embodiment includes a mixer 115 located in a portion where cleaning gas and ozone gas supplied from a cleaning gas supply unit 120 and an ozone gas supply unit 130 are mixed, in order to mix the gases and supply the mixed gas into a reaction chamber 110. Therefore, cleaning gases that have to be uniformly mixed can be supplied in a mixed gas type. Accordingly, a complex flux type cleaning gas is supplied to improve a cleaning efficiency of the semiconductor wafer.

The apparatus for cleaning semiconductor wafers according to embodiments of the present invention has the following advantages:

First, the cleaning additive gas and ozone gas are mixed and supplied onto semiconductor wafers in a cleaning process of a photoresist that has undergone a predetermined plasma or ion implanting process so that a hardened photoresist can be easily removed.

Second, a cleaning solution is transformed into vapor under a predetermined pressure so that the amount of cleaning solution for cleaning the semiconductor wafers is reduced. Therefore, the cost for fabricating semiconductor wafers can be reduced.

Third, the present invention does not use a cleaning solution in a liquid state for cleaning the semiconductor wafers so that a separate bath for storing the cleaning solution and replacing the cleaning solution are not required. Therefore, the apparatus requires a reduced time for maintenance operations so that the rate of operating the apparatus improves.

While this invention has been particularly shown and described with regerence to preferred embodiments thereof, the preferred embodiments described above are merely illustrative and are not intended to limit the scope of the invention. It will be understood by those skilled in the art that various changes in form and details may be made therein without departing from the spirit and scope of the invention as defined by the appended claims.

What is claimed is:

1. An apparatus for cleaning a semiconductor wafer, the apparatus comprising:
a reaction chamber for performing a cleaning process;
a wafer loading unit for loading a semiconductor wafer;
at least one cleaning gas supply unit for supplying at least one cleaning solution in a gas state into the reaction chamber;
an ozone supply unit for supplying ozone gas into the reaction chamber;
a water vaporizing unit for supplying water vapor onto the semiconductor wafers in the reaction chamber; and
a reaction gas exhaustion unit connected to the reaction chamber, for exhausting the cleaning gas from the reaction chamber.

2. The apparatus of claim 1 further including the wafer unit for loading at least one semiconductor wafer, and a wafer conveyor for transferring the semiconductor wafers to the wafer loading unit.

3. The apparatus of claim 1, wherein the reaction chamber further includes a reaction chamber heating unit substantially surrounding the outer sides of the reaction chamber to furnish heat to the inside of the reaction chamber.

4. The apparatus of claim 1, wherein the cleaning gas supply unit includes:
a cleaning solution supply unit for storing the cleaning solution; and
a solution vaporization unit connected to the cleaning solution supply unit, for vaporizing the cleaning solution.

5. The apparatus of claim 4, wherein the cleaning solution is one of hydrofluoric acid (HF), ammonium hydroxide (NH₄OH), and hydrogen peroxide (H₂O₂).

6. The apparatus of claim 4, wherein the cleaning solution supply unit further includes a bubbling pipe for supplying a gas into the cleaning solution supply unit and bubbling the gas through the cleaning solution.

7. The apparatus of claim 6, wherein the gas is an inactive gas.

8. The apparatus of claim 7, wherein the bubbling gas is one of argon (Ar), nitrogen (N₂), and helium (He).

9. The apparatus of claim 4, wherein the solution vaporization unit is a spray device applied according to Bernoulli's law.

10. The apparatus of claim 1, wherein the ozone supply unit is an ozone generator.

11. The apparatus of claim 1, wherein the cleaning gas exhaustion unit is disposed at a lower portion of the reaction chamber.

12. The apparatus claim 11, wherein the cleaning gas exhaustion unit further includes a gas scrubber installed at the outside of the reaction chamber.

13. The apparatus of claim 1, wherein process pressure in the reaction chamber is higher than one atmosphere.

14. The apparatus of claim 12, wherein the process pressure is about 1.5 to about 3 atmospheres.

15. A method for cleaning a semiconductor wafer using an apparatus for cleaning a semiconductor wafer, the apparatus includes a reaction chamber, a wafer conveyor for loading semiconductor wafers onto a loading unit inside the reaction chamber, a cleaning gas supply unit for supplying vaporized cleaning solution into the reaction chamber, an ozone gas supply unit for supplying ozone gas into the reaction chamber, and a gas exhaustion unit for exhausting the gases from the reaction chamber, the method comprising:
(a) loading semiconductor wafers in a reaction chamber;
(b) vaporizing a cleaning solution and distilled water;
(c) supplying the vaporized cleaning solution, the vaporized distilled water, and ozone gas into the reaction chamber while controlling the flow rate of the gases; and
(d) impregnating the semiconductor wafers with the cleaning gas and the ozone gas in order to clean the semiconductor wafers while exhausting predetermined amounts of cleaning gas and ozone gas out of the reaction chamber.

16. The method of claim 15, wherein vaporizing a cleaning solution and distilled water further includes:
heating the cleaning solution; and
bubbling an inactive gas through the cleaning solution to generate the cleaning gas.

17. The method of claim 15, wherein vaporizing a cleaning solution and distilled water uses a spray method based on Bernoulli's law, using a pressure difference.

18. The method of claim 15, wherein the cleaning solution includes a HF solution.

19. The method of claim 15, wherein the cleaning solution includes NH₄OH solution.

20. The method of claim 15, wherein the cleaning solution includes H₂O₂.

21. The method of claim 15, wherein vaporizing a cleaning solution and distilled water further includes heating the reaction chamber to a predetermined temperature.

22. The method of claim 15, wherein supplying the cleaning gas, the vaporized distilled water, and ozone gas into the reaction chamber while controlling the flow rate of the gases further includes generating ozone gas by using an ozone generator.

23. The method of claim 15, wherein supplying the cleaning gas, the vaporized distilled water, and ozone gas into the reaction chamber while controlling the flow rate of the gases further includes maintaining a predetermined process pressure in the reaction chamber.

24. The method of claim 23, wherein the supplied amounts of the cleaning gas and the ozone gas and the exhausted amount of the exhaustion gas are controlled to maintain a constant pressure in the reaction chamber.

25. The method of claim 24, wherein the process pressure is in a pressurized state.

26. The method of claim 25, wherein the pressure in the reaction chamber is about 1.5 to about 3 atmospheres.

27. The method of claim 15, wherein in impregnating the semiconductor wafers with the cleaning gas and the ozone gas to clean the semiconductor wafers while exhausting predetermined amounts of cleaning gas and ozone gas out of the reaction chamber further includes the cleaning gas, the vaporized distilled water, and the ozone gas being sprayed from different directions onto the semiconductor wafers.

28. The method of claim 15, wherein in impregnating the semiconductor wafers with the cleaning gas and the ozone gas in order to clean the semiconductor wafers while exhausting predetermined amounts of cleaning gas and ozone gas out of the reaction chamber further includes the cleaning gas, the vaporized distilled water, and the ozone gas are mixed and supplied into the reaction chamber.

29. The method of claim 27, wherein the cleaning gas and the ozone, gas are supplied from an upper portion of the reaction chamber.

30. The method of claim 28, wherein the cleaning gas and the ozone gas are supplied from an upper portion of the reaction chamber.

31. The method for cleaning a semiconductor wafer of claim 15, wherein the semiconductor wafers are placed parallel to the flow direction of the cleaning gas and the ozone gas entering the reaction chamber.
